(19) United States
(12) Patent Application Publication
(10) Pub. No.: US 2018/0044031 A1
(43) Pub. Date: Feb. 15, 2018

(54) TURBOFAN ENGINE COMPRISING AN OVERPRESSURE FLAP AT A FAIRING BEING LOCATED AT THE SECONDARY FLOW CHANNEL

(71) Applicant: Rolls-Royce Deutschland Ltd & Co KG, Blankenfelde-Mahlow (DE)

(72) Inventors: Robert THIES, Schwielowsee (DE); Michael SCHULZ, Potsdam (DE)

(21) Appl. No.: 15/672,837

(22) Filed: Aug. 9, 2017

(30) Foreign Application Priority Data
Aug. 11, 2016 (DE) 10 2016 215 036.7

(51) Int. Cl. B64D 29/06; F02K 3/06; F01D 9/02; F02K 1/52; F02C 7/04

(52) U.S. Cl. CPC B64D 29/06; F02K 1/52; F02C 7/04; F01D 9/02; F02K 3/06; F01D 25/28

(57) ABSTRACT

A turbofan engine including a core engine and at least one fan by means of which fluid is guided to a primary flow channel for the core engine as well as to a secondary flow channel of the turbofan engine, wherein the secondary flow channel extends around the core engine, and at least one conduit guided inside a hollow space of a splitter fairing that is arranged in the secondary flow channel. The splitter fairing has at least one overpressure flap with at least one deformable hinge element, with the overpressure flap being flappable as the deformable hinge element is being deformed if a pressure inside the hollow space exceeds a threshold value. Further, at least one opening mechanism is provided by means of which, in the event that the pressure inside the hollow space exceeds a threshold value, a fixation of the overpressure flap is released.

### REFERENCE TO RELATED APPLICATION

This application claims priority to German Patent Application No. 10 2016 215 036.7 filed on Aug. 11, 2016, the entirety of which is incorporated by reference herein.

### BACKGROUND

The invention relates to a turbofan engine.

Turbofan engines are also referred to as turbofans or bypass engines. They are characterized by the fan (also referred to as a blower) being driven by a turbine that is arranged behind the combustion chamber of the turbofan engine, wherein a large portion of the air mass that is [sucked in] by the engine is accelerated past a core engine which comprises the combustion chamber. Here, the turbofan engine forms a primary flow channel through the core engine as well as a secondary flow channel for an outer fluid flow that is guided past the core engine.

Different conduits are installed inside the turbofan engine. In particular, the conduits have to be guided radially outward through the secondary flow channel. For example, air is conducted in such conduits under a comparatively high pressure. Here, in order to be able to guide the conduits through the secondary flow channel in such a manner that they are protected from outer influences, a splitter fairing is usually provided, which forms a hollow space for the conduits. This splitter fairing is arranged inside the secondary flow channel and in particular extends through the secondary flow channel in the radial direction with respect to a central axis of the turbofan engine.

In practice, a respective splitter fairing is usually provided with a passage opening or with multiple passage openings in order to reduce the overpressure inside the hollow space in the event of a break or other kind of failure of a conduit caused by leakage of a fluid from the conduit. However, in this way the respective splitter fairing is regularly designed in a manner that is comparatively disadvantageous from the aerodynamic point of view.

What is known from US 2011/0240137 A1 is to provide at least one overpressure flap at an engine nacelle in order to facilitate that the fluid flows out into an exterior space that surrounds the engine in the event that a conduit inside of which the pressurized fluid is conducted fails. Here, US 2011/0240137 A1 provides that at least one overpressure flap is provided at an outer wall of the engine nacelle, which, in the event of overpressure, can be flapped open in an outward direction at the engine nacelle by means of failing attachment elements, for example by rivets that re provided with a predetermined breaking point.

### SUMMARY

In contrast to that, the invention is based on the objective to facilitate an aerodynamically advantageous design at a splitter fairing of a turbofan engine, which is located within a secondary flow channel of a turbofan engine.

This objective is achieved with a turbofan engine with features in as described herein.

According to the invention, the splitter fairing that is located inside the secondary flow channel (also referred to as the bypass channel or the bypass duct) has at least one overpressure flap with at least one elastically or plastically deformable hinge element, wherein the overpressure flap can be flapped open as the hinge element is being deformed if a pressure inside a hollow space of the splitter fairing receiving at least one conduit exceeds a threshold value. Further, at least one opening mechanism is provided by means of which a fixation of the overpressure flap is released in the event of the pressure inside the hollow space exceeding a threshold value, so that flapping out of the overpressure flap is facilitated. In this manner, fluid, which may for example flow from a broken conduit, can flow out from the hollow space of the splitter fairing in the direction of the secondary flow channel through an opening that is opened by the overpressure flap being flapped out.

By providing at least one overpressure flap at the splitter fairing that is located inside the secondary flow channel, the splitter fairing can be designed so as to be aerodynamically advantageous for a normal operational state. An aerodynamically disadvantageous passage opening for pressure reduction in the case that a conduit extending inside the splitter fairing brakes is closed by at least one overpressure flap, and is released by the opening mechanism and the pressed-open overpressure flap only when it is required, i.e. if an overpressure occurs.

In one embodiment variant, it is provided that the opening mechanism comprises at least one arresting appliance that arrests the overpressure flap at the splitter fairing in a closed position in which it is not flapped open, and releases the overpressure flap in the event that the pressure inside the hollow space exceeds the threshold value, so that the overpressure flap protrudes at least partially into the secondary flow channel. By means of the at least one arresting appliance it is thus facilitated that the overpressure flap can be opened to at least to a certain degree. Here, any possible further flapping open of the overpressure flap can then be effected by making use of the flow inside the secondary flow channel. In this way, the overpressure flap can protrude in such a manner into the flow path of the fluid flow inside the secondary flow channel in a partially opened position that is released by the arresting appliance that the overpressure flap is flapped open further by the fluid flow.

Against this background, it is for example provided in a possible further development that, if the overpressure flap is opened by the arresting appliance, the hinge element
a) allows for a flapping of the overpressure flap into an intermediate position in which a part of the overpressure flap protrudes into the secondary flow channel, and
b) subsequently allows for the overpressure flap to be flapped open further under the influence of the fluid that is flowing inside the secondary flow channel and impinges on that part of the overpressure flap that is projecting into the secondary flow channel.

Thus, a two-step opening of the overpressure flap is facilitated through the hinge element and the arresting appliance if the pressure inside the hollow space exceeds the threshold value. At first, a first flap-out movement with a comparatively small adjustment track into the intermediate position is allowed, in which fluid can already exit from the hollow space. During operation of the turbofan engine, the overpressure flap is flapped open further and possibly flapped all the way around by the fluid flow inside the secondary flow channel, and thus the overpressure flap is forced into a second flap-out movement along a usually considerably larger adjustment track.

Here, the first flap-out movement into the intermediate position can be controlled solely through the pressure inside the hollow space which has exceeded the threshold value. Alternatively or additionally, the overpressure flap can be pre-stressed in the direction of the intermediate position, in particular it can be pre-loaded by means of a spring. Here, a corresponding preload in a flap-out direction can be applied, e.g. through a spring element of the arresting appliance against which the overpressure flap rests in its closed position or against which the overpressure flap is supported in its closed position. Such a spring element can for example be formed by a pressure spring, a rubber lining at the edge of the overpressure flap and/or at an area of the splitter fairing in the environment of the overpressure flap and/or by a rubber component between the overpressure flap and an edge of a passage that is closed by the overpressure flap.

In connection with the exemplary embodiment described above, in which a two-step flap-out movement of the overpressure flap is provided and the further flapping open is to occur after the release of the overpressure flap with the supported by the fluid flow inside the secondary flow channel, a fast further flapping-out process of the overpressure flap (in the second flapping-open movement) can be supported by a corresponding arrangement of the hinge element and the arresting appliance relative to one another. For example, it is provided in one embodiment variant that the hinge element and the arresting appliance are arranged in such a manner at the splitter fairing, that, in the event of the pressure inside the hollow space exceeding a threshold value, the overpressure flap that is released by means of the arresting appliance is flapped into an intermediate position, in which that part of the overpressure flap that protrudes into the secondary flow channel is positioned upstream of the hinge element with respect to the flow direction of the fluid flowing inside the secondary flow channel. Thus, the force of the flowing fluid acts in the direction of the hinge element if the overpressure flap is in the intermediate position. In this way, the overpressure flap is flapped out further directly in the flow direction.

In one embodiment variant, the opening mechanism has at least one previously defined weakening area, at which, in the event of the pressure inside the hollow space exceeding a threshold value, a material failure occurs in order to permit the overpressure flap to be flapped out. Therefore, in this variant—either alternatively or additionally to an arresting appliance of the opening mechanism—a material failure is allowed to occur in a targeted manner at least in one position in order to allow for the overpressure flap to be pressed open as a result of the pressure exceeding the threshold value.

In one embodiment variant with an arresting appliance, a fixation of the overpressure flap in the closed position can be provided by means of an arresting piece that fails in the event of overpressure, for example. Such an arresting piece, for example in the form of a pin or bolt, can be supported at an edge of the passage opening that is closed by the overpressure flap and at the overpressure flap, and can be designed in such a manner that the arresting piece fails in the event of overpressure, for example due to shear, and thus releases the overpressure flap. In one variant, a corresponding arresting piece is for example made of a brittle material, for example of a ceramic material, and has comparatively small dimensions, so that it fails in the event that the pressure inside the hollow space exceeds the predefined threshold value.

In a further development, the arresting piece can be attached subsequently at the closed overpressure flap during mounting of the splitter fairing in order to fixate the overpressure flap in the closed position. For this purpose, an elongated arresting piece can for example be inserted at a first part of the arresting appliance at the edge of the passage opening and at a second part of the arresting appliance at the overpressure flap, and can be locked in a locking position in which both parts are connected to each other in a rigid manner by means of the arresting piece. For example, the locking is effected by means of a separate locking element that secures the arresting piece against any displacement from the locking position.

The at least one weakening area, for example in the form of a predetermined breaking point, can be formed at an element and/or a section by means of which the overpressure flap is held in a closed position in which it is not flapped out. Thus, the overpressure flap can only be flapped by a pivot axis defined by the at least one hinge element as a result of the failure at the weakening area, so that an overpressure that is created inside the hollow space of the splitter fairing is reduced.

For that purpose, in one embodiment variant, the at least one weakening area is formed at an element that is connected to the overpressure flap. Here, the at least one weakening area can be formed at an attachment element, such as for example a bolt, pin or rivet by means of which the overpressure flap is fixated in the closed position with respect to a shell surface of the splitter fairing and which fails at the at least one weakening area in a defined manner if the pressure inside the hollow space exceeds a threshold value. At that, a controlled failure of the respective attachment element can be realized e.g. in particular by means of shear. If, for example, a pressure inside the hollow space (strongly) rises due to a burst conduit, a rivet that holds the overpressure flap in its position and that is provided with a predetermined breaking point fails and thus does no longer block the overpressure flap from flapping out.

In one embodiment variant, the overpressure flap is fixated in the closed position through multiple (at least two) retaining elements that are provided at a shell surface of the splitter fairing, i.e. that are fixated or formed at the same. At that, the overpressure flap is connected to each retaining element by means of at least one attachment element that has at least one weakening area. Through the individual retaining elements, the overpressure flap is thus retained in its position at the shell surface of the splitter fairing. However, in the case than an overpressure occurs inside the hollow space (as compared to a normal operational state), the individual attachment elements can fail in a controlled manner at the respective weakening area, for example a predetermined breaking point, so that the overpressure flap is no longer connected with the respective retaining element and can be flapped out by means of the at least one deformable hinge element. The retaining elements can be formed in a lug-like manner, for example. In one variant, the retaining elements are fixated or formed, on the one hand, at an edge of a passage opening formed in the shell surface of the splitter fairing, so that an end of the respective lug-like retaining element protrudes into the passage opening. Then, the overpressure flap is respectively fixated by means of an attachment element provided with a predetermined breaking point at an end of a retaining element that protrudes in a lug-like manner into the passage opening.

Alternatively or additionally, the at least one weakening area can be formed between two separately flappable sections of the overpressure flap itself. Thus, what is provided through the at least one weakening area is an at least two-part overpressure flap in which the individual flap sections can be flapped outward about separate hinge elements in the case of overpressure. Such an at least two-part overpressure flap can for example also be formed at a trailing edge of the splitter fairing, i.e. at an edge of the splitter fairing that lies in the flow direction of the fluid inside the secondary flow channel. Here, a predetermined breaking point can for example extend at a trailing edge of the splitter fairing itself, so that, in the case of an overpressure, the splitter fairing brakes at a trailing edge, and a rear section that tapers off towards the trailing edge and is thus formed in an aerodynamically advantageous manner can be widened to let fluid leak into the secondary flow channel. Accordingly, flapping out of the splitter fairing at a trailing edge that is positioned in the flow direction is facilitated by means of at least one predetermined breaking point, so that a part of the splitter fairing that defines the trailing edge forms an overpressure flap having at least two parts.

The above-mentioned embodiment variants have in common that, if a pressure inside the hollow space of the splitter fairing exceeds a threshold value, the overpressure flap can be flapped into the secondary flow channel as the at least one hinge element is being deformed. Thus, a passage opening that connects the hollow space with the secondary flow channel is opened by the overpressure flap being flapped out.

However, in contrast to that it can also be provided that an overpressure flap of the splitter fairing opens a passage opening which only connects the hollow space of the splitter fairing accommodating the at least one conduit with an intermediate space that is formed by a trailing edge element which is connected to the splitter fairing. Such a separate trailing edge element is preferably connected to the splitter fairing in a releasable manner and defines a trailing edge that is positioned in a flow direction of the fluid inside the secondary flow channel. While in this case the splitter fairing is thus formed with a focus on sufficient strength and stiffness in the event of a failing conduit, and if necessary is also made of a fire-proof material, the separate trailing edge element only serves the purpose of guiding the [fluid] flowing inside the secondary flow channel above and over the splitter fairing and the trailing edge element in an aerodynamically advantageous manner. Here, the trailing edge element that is attached at the splitter fairing can for example be formed so as to be tapering off in the flow direction. For example, the trailing edge element thus forms an intermediate space that is substantially triangular in cross-section and into which fluid from the hollow space of the splitter fairing flows if overpressure occurs and after the overpressure flap has been flapped out.

In order to facilitate flowing out of fluid from the intermediate space of the trailing edge element into the secondary flow channel, the trailing edge element can for example have a passage opening that connects the intermediate space with the secondary flow channel. In the event of overpressure, the fluid can thus flow from the hollow space into the intermediate space via the passage opening opened by the overpressure flap of the splitter fairing, and from there into the secondary flow channel via a further passage opening of the trailing edge element that is always open.

Alternatively or additionally, the trailing edge element can have at least one (additional) overpressure flap, which can be flapped at the trailing edge element into the secondary flow channel in the event that a failure occurs at least at one further weakening area, with at least one further hinge element being deformed if a pressure inside the intermediate space exceeds a (different or identical) threshold value. What is thus provided in this variant is a two-step pressure reduction by means of different and successively flappable overpressure flaps on the one hand at the splitter fairing and on the other hand at the separate trailing edge element. If a pressure rises inside the hollow space of the splitter fairing, for example due to the failure of a conduit inside of which compressed air is conducted, namely to such a degree that the overpressure flap of the splitter fairing is pressed open, fluid enters the intermediate space of the trailing edge element and causes the pressure to rise here as well to such an extent that a trailing edge overpressure flap is subsequently pressed open. This trailing edge overpressure flap then flaps into the secondary flow channel, so that only then a (larger) mass flow can escape into the secondary flow channel.

### BRIEF DESCRIPTION OF THE DRAWINGS

The accompanying Figures illustrate possible embodiment variants of the invention by way of example.

FIGS. 1A-1B show an embodiment variant of a turbofan engine according to the invention respectively in a perspective view, with the core engine cover and the cladding of a secondary flow channel being omitted.

FIGS. 2A-2B show, in sections, respectively a splitter fairing of the turbofan engine for a conduit to be guided radially inside the secondary flow channel with a closed (FIG. 2A) and flapped out (FIG. 2B) overpressure flap.

FIG. 3 shows, in a perspective view, a further variant of a splitter fairing for the conduit guidance the secondary flow channel with an overpressure flap that can be flapped outward into the secondary flow channel at a lateral shell surface of the splitter fairing.

FIG. 4A shows, in a lateral view and in an enlarged rendering, [the overpressure flap] of FIG. 3 with a view onto an inner side of the lateral shell surface.

FIG. 4B shows, in sections, the inner side of the lateral shell surface of the splitter fairing provided with the overpressure flap of FIG. 3.

FIG. 4C shows, in sections, a lateral and a rear shell surface of the splitter fairing of FIG. 3 with two possible alternatively embodied overpressure flaps.

FIG. 5A shows a perspective view of the splitter fairing with an overpressure flap that is provided on a facing side of the shell surface.

FIG. 5B shows, in sections, the splitter fairing of FIG. 5A with a view onto an inner side of the overpressure flap and an arresting appliance fixating the overpressure flap in the closed position.

FIGS. 6A-6D shows the overpressure flap of FIGS. 5A and 5B in different phases of a multi-stage flapping-out process.

FIGS. 7A-7D shows different views of an embodiment variant with an overpressure flap that is fixated in a closed position by means of an arresting appliance having an arresting pin that fails in the event of overpressure.

### DETAILED DESCRIPTION

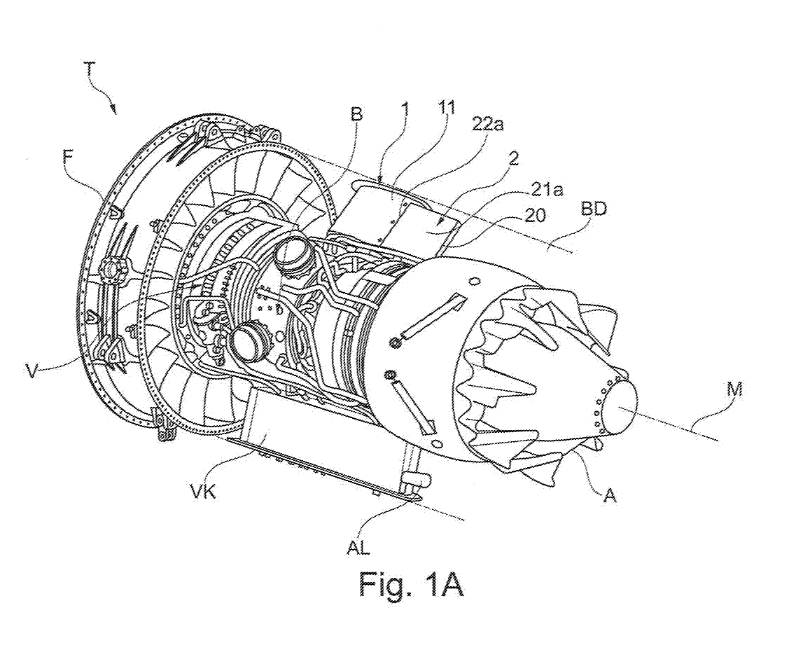

FIGS. 1A and 1B show, in perspective renderings, a turbofan engine T, in which a fan F, a compressor V, a combustion chamber section B, a turbine TT and an outlet A are arranged behind each other along a central axis M of the turbofan engine T in a per se known manner. The compressor V typically comprises a low-pressure, medium-pressure and high-pressure compressor. Likewise, a high-pressure, medium-pressure and low-pressure turbine is part of turbine TT, via which the fan F is driven. The compressor V, the combustion chamber section B and the turbine TT are part of a core engine K of the turbofan engine T, to which a primary flow of inflowing fluid is supplied via the fan F. A corresponding primary flow channel for the inflowing fluid consequently extends through the core engine K along the central axis M.

In addition to that, for creating a large portion of the thrust, a secondary flow channel is provided in the form of a bypass channel BD surrounding the core engine K. Via the fan F, this bypass channel BD is supplied with a large portion of the inflowing fluid, which is conveyed in the direction of the outlet A. At that, the bypass channel BD is delimited by a radially inner core engine cover or inner bypass channel wall, which is not shown in FIGS. 1A and 1B, and a radially outer external bypass channel wall, which is also not shown in FIGS. 1A and 1B.

In the present case, two splitter fairings 1 and VK, which are respectively designed in a housing-like manner, are provided inside the bypass channel BD. These (top and bottom) splitter fairings 1 and VK are arranged completely inside the bypass channel BD and extend with respect to the central axis M in the radial direction between the core engine cover and the bypass channel wall, which is located further externally with respect to the radial direction. The splitter fairings 1 and VK also extend respectively in that flow direction in which the fluid flows from the fan F through the bypass channel BD in the direction of the outlet. At that, the splitter fairings 1 and VK are respectively provided for the protective cladding of different conduits which extend in the radial direction with respect to the central axis M and which have to be passed through the bypass channel BD in the radial direction. For example, fuel, oil or air may be conducted inside these conduits. For example, an outlet conduit AL is additionally provided at the one splitter fairing VK, providing a fluid connection between a hollow space inside the engine nacelle and the bypass channel BD.

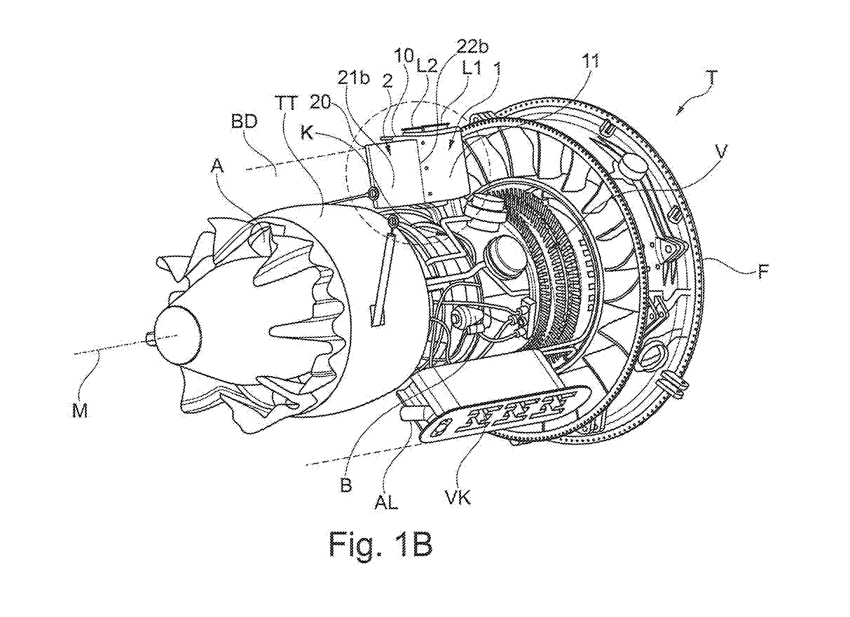

The splitter fairings 1 and VK are arranged so as to be offset with respect to one another along the circumference of the core engine K, and in the present case accommodate different conduits. For example, at least two conduits L1 and L2 are received inside the splitter fairing 1 inside a hollow space H (cf. FIG. 2B) defined by the splitter fairing 1, respectively conducting pressurized air. For this purpose, the splitter fairing 1 is embodied as a hollow cylinder.

The splitter fairing 1 is provided with an overpressure flap which allows for fluid to escape in the direction of the bypass channel BD in the event of an overpressure occurring inside the hollow space 100 that it encloses, for example due to one of the conduits L1 or L2 breaking. A corresponding overpressure flap is provided at the lateral shell surface 11 or a rear shell surface 10, for example (cf. FIGS. 2A to 4C).

In the present case, a separate trailing edge element 2 is connected in a releasable manner with the splitter fairing 1 in the area of the rear shell surface 10, in a manner corresponding to FIGS. 1A and 1 B. The trailing edge element 2 tapers off in the flow direction of the fluid conducted inside the bypass channel BD, so that an improved flow profile results for the splitter fairing 1 that is provided with the trailing edge element 2.

In a possible further development, the trailing edge element 2 forms a weakening area in the form of a longitudinally extending predetermined breaking point 20 in the area of the trailing edge. Through this predetermined breaking point 20, which in the present case extends radially, the trailing edge element 2 can fail in a controlled manner in the event that a higher pressure is internally applied. At that, the trailing edge element 2 is separated into two flap sections 21a and 21b at the predetermined breaking point 20, with the flap sections 21a and 21b respectively being still fixated at a lateral shell surface 11 of the splitter fairing 1. In this way, thee flap sections 21a, 21b can be displaced with respect to each other after a break along the predefined yield line as defined by the predetermined breaking point 20 in the area of the original trailing edge. Thus, the trailing edge element 2 can be widened if the internal pressure rises in order to let the fluid flow out into the bypass channel BD, and namely in the flow direction along the central axis M. At that, the linking of a flap section 21a, 21b to the respective lateral shell surface 11 of the splitter fairing 1 serves as a hinge element 22a or 22b, at which the deformation is allowed to occur in a controlled manner so that the respective flap section 21a and 21b can be bent open and flapped outward.

In contrast to the rendering of FIGS. 1A and 1 B, the trailing edge element 2 can also be an integral component of the splitter fairing 1. Therefore it is not necessary to provide a separate pressure body for receiving the conduits L1 and L2 and additionally also a trailing edge element 2 attached to the same. Rather, in this case the splitter fairing 1 is already integrally formed at the trailing edge element 2, which may possibly have a tapering shape and which fails at a predetermined breaking point 20 at the trailing edge in a controlled manner in the event of a break of a conduit L1 or L2, and can be widened in order to let air flow from the interior of the splitter fairing 1 into the bypass channel BD, for example.

In another embodiment variant, an overpressure flap 3 is embodied at a lateral shell surface 11 of the splitter fairing 1 and thus independently of a trailing edge element 2. For example, in an embodiment variant corresponding to FIGS. 2A and 2B, a locally reduced wall thickness for forming a hinge element 30 is provided at a lateral shell surface 11 delimiting the hollow space 100 for the conduits L1 and L2. Bending of the material of the splitter fairing 1 is allowed to occur at this hinge element 30 in a controlled manner if a pressure inside the hollow space 100 exceeds a predetermined threshold value. Here, the overpressure flap 3 can be flapped about a bend axis by means of the hinge element 30 at the lateral shell surface 11 and is cut out through an otherwise circumferential gap 23 at the lateral shell surface 11.

In the embodiment variant of FIGS. 2A and 2B, a retaining tap 31 is provided as part of an opening mechanism in order to ensure that the overpressure flap 3 flaps outwards in the direction of the bypass channel BD only if an overpressure is created, and that it otherwise remains in a closed position. This retaining tap 31 is fixated at an inner side of the lateral shell surface 11 or formed at the same, and is connected to the overpressure flap 3 by means of a retaining pin 310. The retaining pin 310 is provided with a predetermined breaking point 3100. The retaining pin fails at this predetermined breaking point 3100 310 if, due to a pressure rising inside the hollow space 100, an outwardly directed force is applied which exceeds a (force) threshold value at the overpressure flap 3. Then, the retaining pin 310 fails in a controlled manner at the predetermined breaking point 3100 and falls apart into two pin halves 310a and 310b. In that case, the overpressure flap 3 is connected to the lateral shell surface 11 only by means of the hinge element 30 that functions as a bending joint, and is flapped outward as a result of plastic, possibly elastic, deformation of the hinge element 30. Subsequently, a passage opening 300 is opened in the lateral shell surface 11 through the outwardly flapped overpressure flap 3, and fluid in larger quantities can flow through passage opening 300 into the bypass channel BD in order to achieve pressure reduction.

The hinge element 30, which in the present case is formed by an area with a locally reduced wall thickness, can be designed in such a manner based on the strength/wall thickness, shape and size of a flattened section that the result is a defined maximum opening angle for the flapped open overpressure flap 3. What is also conceivable is an embodiment of the hinge element 30 that is made of spring steel or a plastic material. In contrast to the shown strip-type embodiment of the hinge element 30, it can of course also be embodied in a geometrically different manner.

In a further development, the gap 32 circumferentially surrounding the overpressure flap 30 at the lateral shell surface 11 at least partially can also be provided with a seal in order to avoid that fluid flows out from the hollow space 100 into the bypass channel BD if the overpressure flap 2 is closed, and allow the fluid to flow out only in the event that a failure occurs in the attachment element in the form of retaining pin 310.

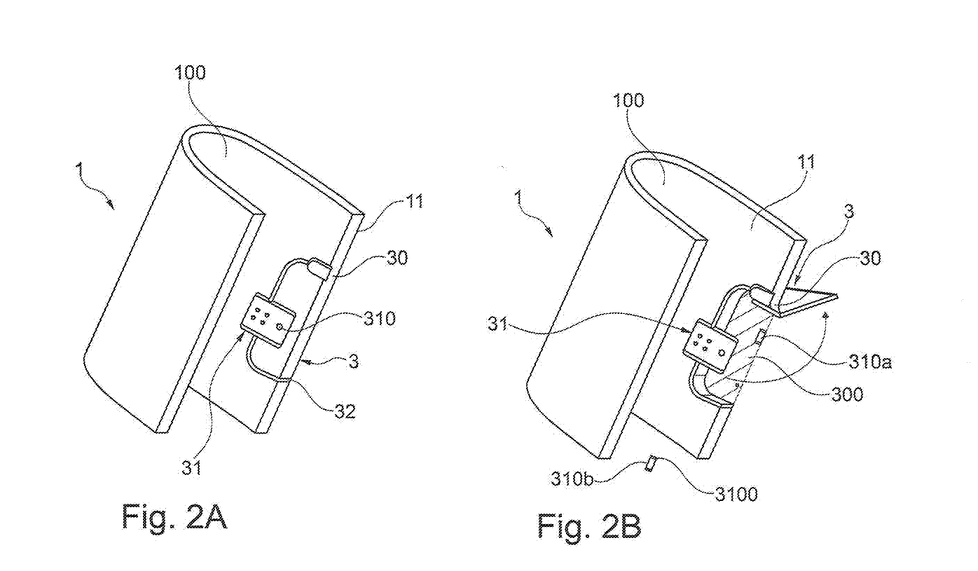

FIG. 3 illustrates an alternatively embodied, hollow-cylindrical splitter fairing 1 in which an overpressure flap 3 is also formed at a lateral shell surface 11. Here, the overpressure flap 3 is held in a closed position by means of an opening mechanism with multiple retaining taps 31.1, 31.2, 31.3 and 31.4. Respectively one retaining pin 310, for example in the form of a rivet, with respectively one predetermined breaking point is provided at each of the retaining taps 31.1-31.4. The overpressure flap 3 is fixedly attached at the dedicated retaining tap 31.1-31.4 by means of the respective retaining pin 310. If an increased pressure is applied inside the hollow space 100, the retaining pins 310 fail and the connection of the overpressure flap 3 to the individual retaining taps 31.1-31.4 is released, so that the overpressure flap 3 can flap outwards at the lateral shell surface 11. At which pressure applied inside the hollow space 100 a flapping out of the overpressure flap 3 occurs, can be set in a controlled manner in particular through the number of retaining pins 310 and/or retaining taps 31.1-31.4 with respectively one retaining pin 310 or multiple retaining pins 310.

The overpressure flap 3 flaps out about a bend axis that is defined by the hinge element 30 as the corresponding hinge element 30 is being deformed. Here, the hinge element 30 is formed by a section of reduced wall thickness at the lateral shell surface 11 where the overpressure flap 3 is still integrally connected to the lateral shell surface 11 and not cut free by a gap 32.

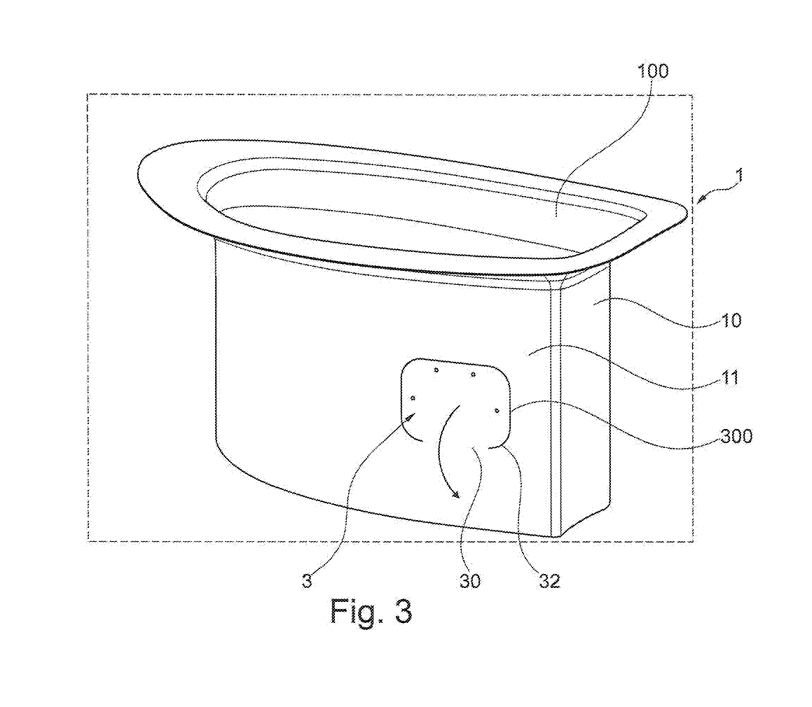

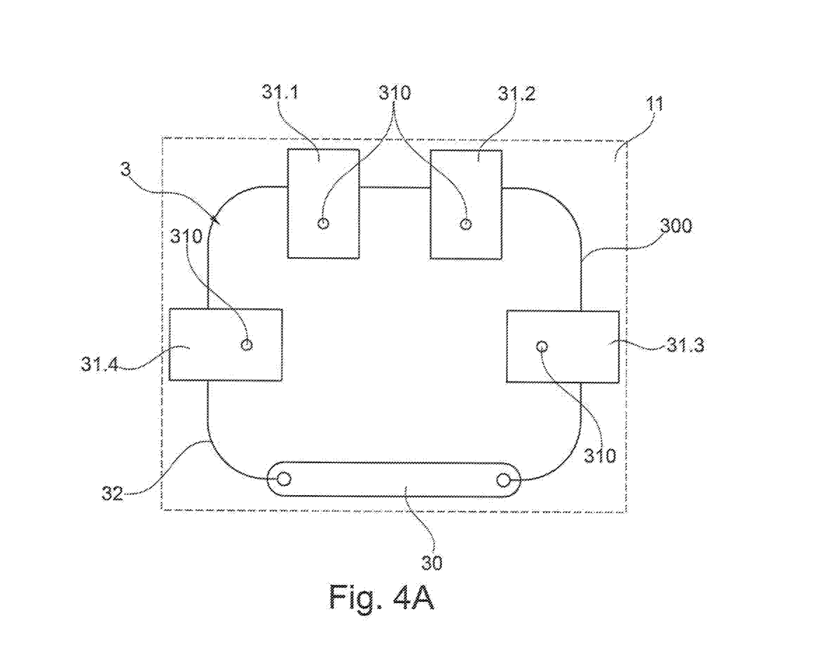

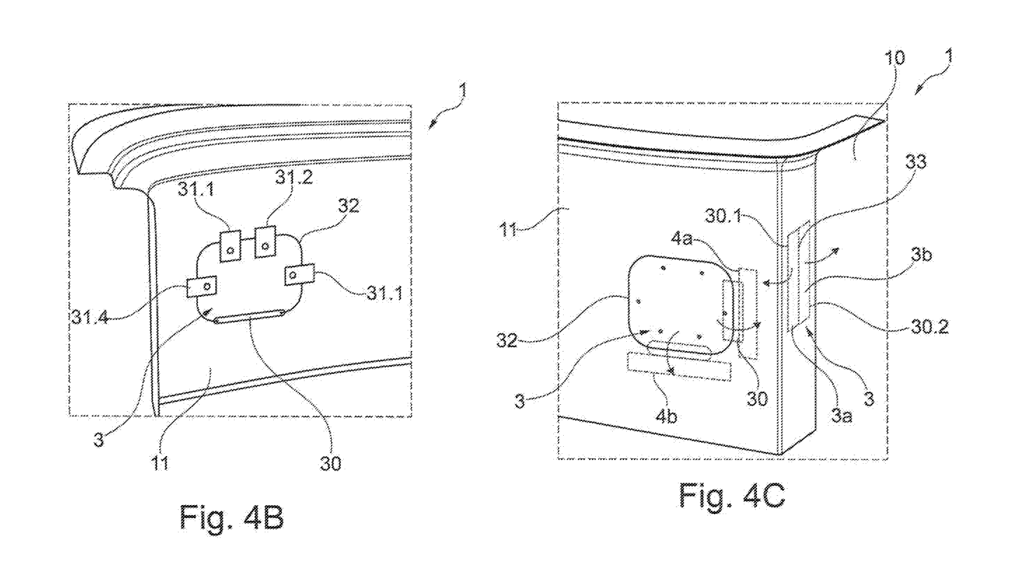

Based on FIGS. 4B, the overpressure flap 3 at the lateral shell surface 11 of the splitter fairing 1 is illustrated in an enlarged scale in a manner corresponding to FIG. 4A. As can be seen here, the retaining taps 31.1-31.4 are attached at an inner side of the lateral shell surface 11 that is facing towards the hollow space 100, and project into the passage opening 300 which is to be opened by the overpressure flap 3.

In this manner, any inward flapping of the overpressure flap 3 into the hollow space 100 is blocked by the retaining taps 31.1-31.4. Thus, even in the case that the retaining pins 310 are broken, the overpressure flap 3 is hindered from flapping inward into the hollow space 100 by the individual retaining taps 31.1-31.4. Ultimately, flapping outwards into the bypass channel BD is allowed only from the closed position.

FIG. 4C illustrates more additional or alternative embodiments of overpressure flaps 3 at the splitter fairing 1 and of opening mechanisms by means of the dashed lines.

Thus, an overpressure flap 3 can also be flapped into the bypass channel BD at the lateral shell surface 11 by means of a hinge element 30 in such a manner that the opening overpressure flap 3 is bent open in the flow direction and thus backwards along the central axis M.

An embodiment of an overpressure flap 3 at a rear shell surface 10 of the splitter fairing 1 is also conceivable, with the overpressure flap being embodied in two-parts with wing-like flap sections 3a and 3b. These flap sections 3a and 3b are embodied in such a manner that they can be flapped open at the rear shell surface 10 as respectively one hinge element 30.1, 30.2 is being deformed, and are connected to each other in the closed state along a predetermined breaking point 33. Here, the predetermined breaking point 33 extends along a predefined yield line, which can for example extend substantially radially to the central axis M, but also obliquely to it, or along a section of a circular arc about the central axis M (the latter variant is not shown in FIG. 4C). The overpressure flap 3 is divided, e.g. lengthwise, by the predetermined breaking point 33, so that in the event of a failure at the predetermined breaking point 33 the individual flap sections 3a and 3b can be flapped open outward in the manner of folding doors as a result of an internally applied pressure. At that, the fluid flows out from the hollow space 100 in the flow direction of the fluid conducted inside the bypass channel BD through an overpressure flap 3 provided at the rear shell surface 10, and from there directly enters the bypass channel BD or an intermediate space that is formed by a trailing edge element 2 provided at the rear shell surface 10.

As can be further seen from FIG. 4C, in a possible further development, planar stiffening areas and elements 4a, 4b can additionally be provided at the edge of the passage 300 and in particular in the area of the hinge element 30, preferably at an inner side of the splitter fairing 1. Through these stiffening areas and elements 4a, 4b, the splitter fairing 1 is reinforced in the area of the passage 300, and it is ensured that the splitter fairing 1 does not fail outside of the passage 300 when the overpressure flap 3 is either being or has been flapped open. For example, areas at the edge of the passage 300, at which the flapping-out overpressure flap 3 that is protruding into the flow of the bypass channel BD introduces forces into the splitter fairing structure, are reinforced in this way in a controlled manner.

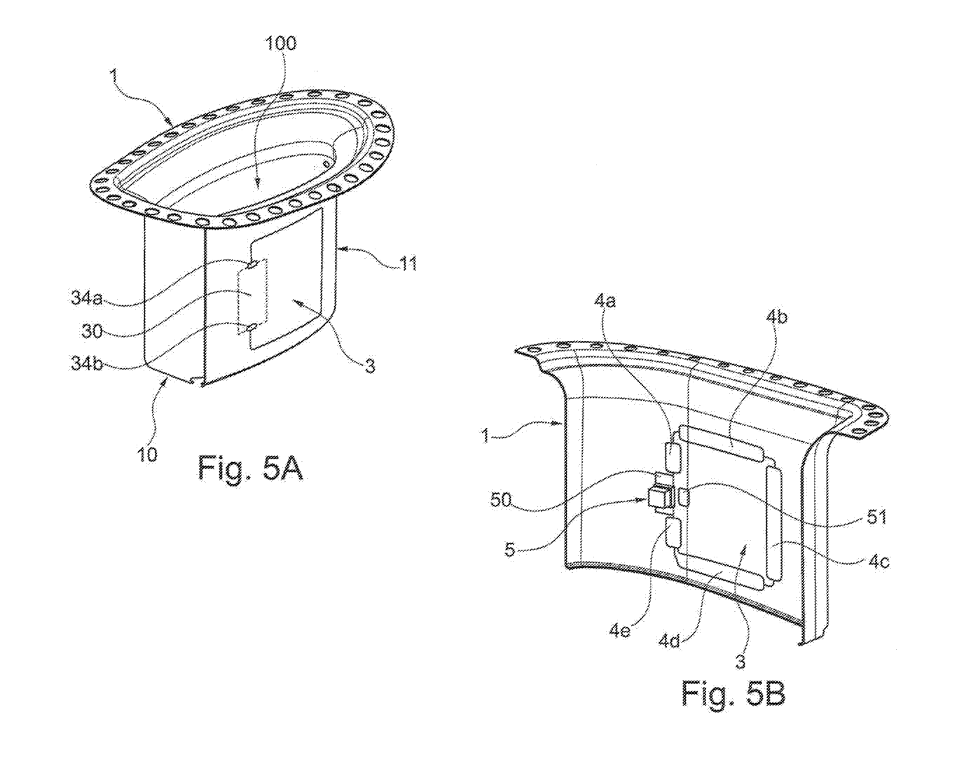

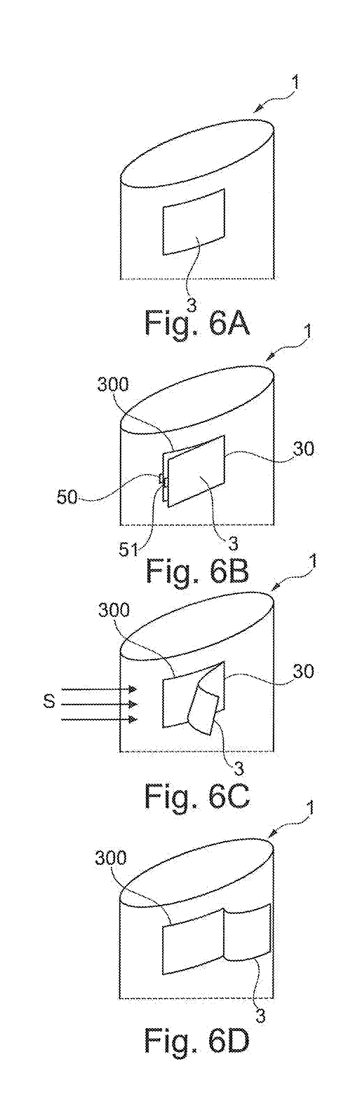

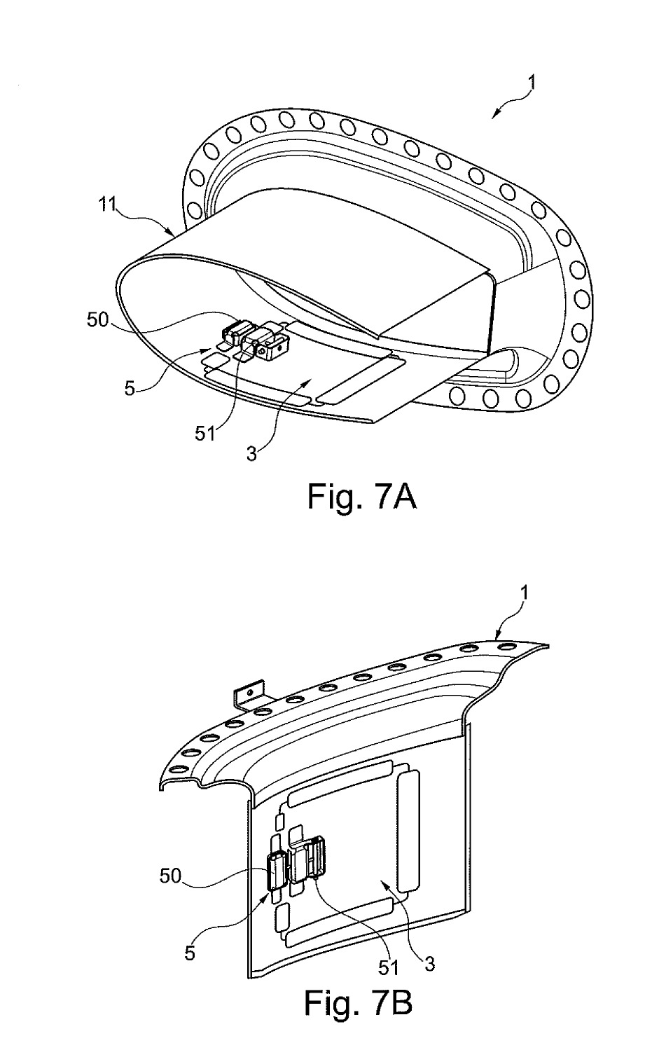

FIGS. 5A to 5B and 6A to 6D illustrate a further embodiment variant in which an overpressure flap 3 provided at the splitter fairing 1 (alternatively or additionally to the attachment elements that are provided with predetermined breaking points) is held in a closed position at the splitter fairing 1 by means of an arresting appliance 5. This arresting appliance 5 is provided at the inner side of the splitter fairing 1 and comprises on the one hand, as a first part, a locking unit 50 at an edge of the passage 300 closed by the overpressure flap 3, and, as a second part, a counterpart at the inner side of the overpressure flap 3, in the present case in the form of an arresting plate 51.

The locking unit 50 comprises an arresting piece 50 that, if required, can be mounted in an adjustable manner and that is provided with a spring, for example in the form of an arresting trunnion or pin mounted in a displaceable manner. The arresting piece meshes with a securing opening of the arresting plate 51 in a form-fit manner so as to retain the overpressure flap 3 in the closed position. If the pressure inside the hollow space 100 exceeds a defined threshold value, the force being applied to the inside of the overpressure flap 3 exceeds the force exerted by the arresting appliance 5, so that the mesh of the arresting piece of the locking unit 50 with the arresting plate 51 or reversely the grip of the arresting plate 51 at the arresting piece of the locking unit 50 is disconnected or the arresting piece fails. In this way, the overpressure flap 3 is released by means of the arresting appliance 5 comprising the opening mechanism.

Consequently, the arresting appliance 5 is designed in such a manner that, in the event that the pressure inside the hollow space exceeds a threshold value 100, the overpressure flap 3 can no longer be retained in its closed position by the arresting appliance 5, and the overpressure flap 3 is released. As a result of the overpressure inside the hollow space 100, the overpressure flap 3 can flap open about the hinge axis defined by the hinge element 30.

Here, the hinge element 30 is arranged downstream of the arresting appliance 5 with respect to the flow direction of the fluid inside the bypass channel BD in a manner corresponding to the rendering of FIG. 5A. The hinge element 30 is in particular formed by the two recesses 34a and 34b that are arranged at a distance from each other along the hinge axis inside the splitter fairing 1. Through the two recesses 34a and 34b at the splitter fairing 1, a material weakening is introduced at the lateral shell surface 11 of the splitter fairing 1 in a controlled manner, so that a bending joint for flapping out the overpressure flap 3 is formed by the hinge element 30. In the present case, the recesses 34a and 34b are present in the form of two elongated holes.

In the present case, the hinge element 30 and the arresting appliance 5 are arranged behind each other with respect to the flow direction of a (bypass) flow inside the bypass channel BD, so that the further flapping out of the overpressure flap 3 occurs after the overpressure flap 3 has been released by the fluid flow in the bypass channel BD. This is illustrated in more detail based on FIGS. 6A to 6D, which show the flapping out of the overpressure flap 3 in different phases.

Accordingly, a two-stepped flapping-out process of the overpressure flap 3 is provided in the present case. At first, the arresting appliance 5 releases the overpressure flap 3, so that the overpressure flap 3 protrudes with a free end into the bypass channel BD upstream of the hinge element 30 if the pressure inside the hollow space 100 exceeds a threshold value. Subsequently, a flow S inside the bypass channel BD is applied to the protruding end of the overpressure flap 3 and presses open the overpressure flap 3 further in the flow direction around the hinge element 30. Thus, in this variant, the opening mechanism for the overpressure flap 3 and the hinge element 30 are adjusted to each other and arranged with respect to one another in such a manner that, in the possible event of an overpressure inside the hollow space 100, at first only an adjustment of the overpressure flap into an intermediate position is allowed, as it is illustrated by way of example in FIG. 6B. After a corresponding first flap-out movement, an end of the overpressure flap 3 protrudes into the bypass channel BD to such a degree that during operation of the turbofan engine T the bypass flow S presses open the overpressure flap 3 further and the overpressure flap 3 flaps around its hinge element 30. A subsequent second flap-out movement of the overpressure flap 3 from the intermediate position is thus carried out primarily or exclusively under the influence of the flow inside the bypass channel BD.

Here, it is to be understood that a two-step flapping-out process of the overpressure flap 3 can of course also be provided in connection with the exemplary embodiments of FIGS. 2A to 4C. At that, the hinge element 30 is respectively designed in such a manner that the maximal overpressure that can occur inside the hollow space 100 leads only to a first flap-out movement of the overpressure flap 3, at the end of which a free end of the overpressure flap 3 protrudes into the bypass channel BD and any further flapping out occurs as a result of the bypass flow.

An adjustment of the overpressure flap 3 into the intermediate position in the course of the first flap-out movement can be supported by a preload of the overpressure flap 3 towards the intermediate position. For example, the overpressure flap 3 can be spring-preloaded in the direction of the intermediate position for this purpose, so that the overpressure flap 3 is pressed in the direction of the intermediate position by a spring force being applied after the overpressure flap 3 has been released by the respective opening mechanism (for example by the failing attachment elements 310 and/or components of an arresting appliance 5 that have been brought out of mesh). A corresponding spring element for exerting a spring force on the overpressure flap 3 can for example comprise a pressure spring that is supported at an edge of the passage 300 on the one hand and, on the other hand, at the overpressure flap 3. Alternatively or additionally, a corresponding rubber lining and/or a rubber component can be provided to apply a preload force to the overpressure flap 3 in the direction of the intermediate position.

In the variant of FIGS. 5A to 5B and 6A to 6D, it can further be seen based on FIG. 5B that a plurality of stiffening areas or elements 4a to 4e can be provided at the edge of the passage 300 in order to counteract the deformation of the edge of the passage 300 off the hinge element 30. For example, planar and if necessary strip-shaped stiffening elements 4a to 4e can be fixated at the inner side of the lateral shell surface 11f, e.g. by means of welding.

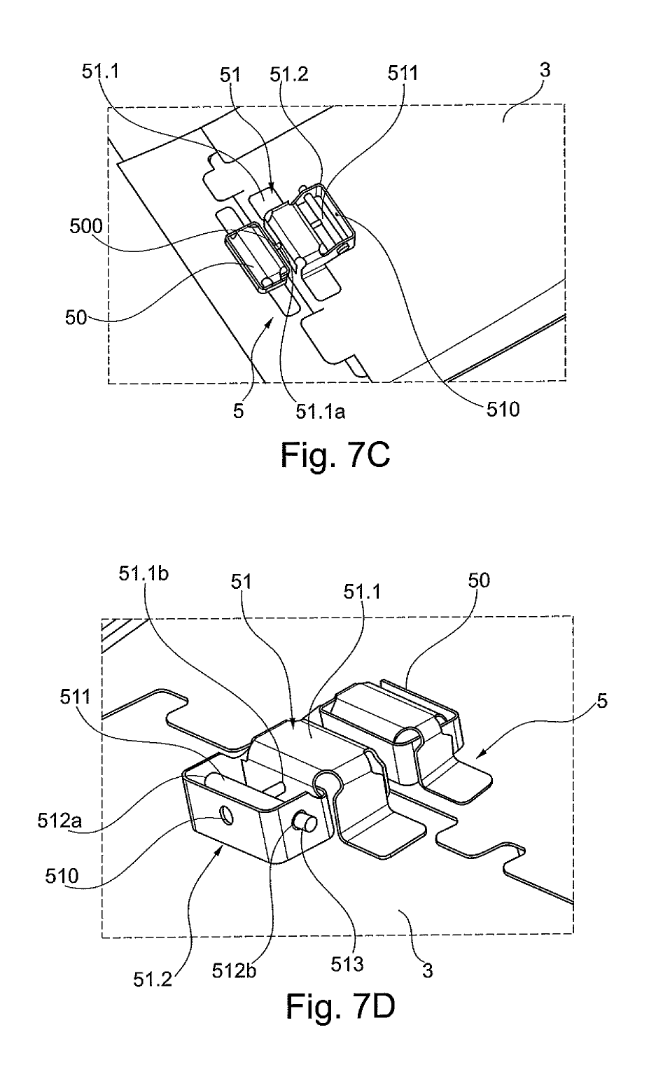

FIGS. 7A to 7D illustrate in more detail an embodiment variant of the splitter fairing 1 that also comprises an arresting appliance 5 for fixating the overpressure flap 3 in a closed position, and initially facilitate a partial opening of the overpressure flap 3 in the event that an overpressure occurs. Here, too, the arresting appliance 5 has a first part in the form of a locking unit 50 at the internal edge of the passage 300 which is closed by the overpressure flap 3, and a second part in the form of an arresting plate 51 at the overpressure flap 3.

In the closed position of the overpressure flap 3, the two parts 50 and 51 of the arresting appliance 5 are arranged opposite each other, so that they can be connected to each other in a rigid manner by means of an arresting piece in the form of an arresting pine 500 that meshes with both parts 50, 51 to fixate the overpressure flap 3 in its closed position. For this purpose, the arresting plate 51 at the overpressure flap 30 has two functional sections 51.1 and 51.2

Here, a first functional section 51.1 is arranged directly opposite to the locking unit 50 in the closed position of the overpressure flap 3 and is arranged at a distance from the same by a narrow intermediate area. The first functional section 51.1 has two securing openings 51.1a and 51.1b which are arranged at an axial distance to one another and through which the arresting pin 500 is passed. At that, the arresting pin 500 protrudes with one end from the arresting plate 51 and is inserted into the locking unit 50, thus bridging the intermediate area, so that the arresting pin 500 is held in a form-fit manner at both parts 50 and 51 of the locking unit 5.

A second functional section 51.2 of the arresting plate 51 provided at the overpressure flap 3 serves, on the one hand, for inserting the arresting pine 500 into the securing openings 51.1a and 51.2b and for inserting into the locking unit 50. On the other hand, the functional section 51.2 serves for securing the arresting pin 500 that is inserted according to the intended use in a locking position that is shown in FIGS. 7A to 7D, in which the arresting pin 500 is held at both parts 50 and 51 of the arresting appliance 5, and namely respectively in two mounting or securing openings of the respective part 50, 51 which are arranged at an axial distance to one another.

In the locking position, the arresting pin 500 is pushed into the locking unit 50 so far that the arresting pin 500 is located with its one end directly adjacent to the wall of the locking unit 50 and any further axial displacement of the arresting pin 500 into that insertion direction along which the arresting pin 500 has been pushed in from the arresting plate 51 into the locking unit 50 is prevented. The thus predefined locking position is subsequently secured at the second functional section 51.2 of the arresting plate 51.

On the one hand, the second functional section 51.2 has a mounting opening 510 through which the arresting pin 500 can be inserted from the outside into the securing openings 51.1a and 51.1b of the first functional section 51.1 and into the locking unit 50. If then the arresting pin 500 takes its locking position, a locking element in the form of a locking pine 511 can be plugged in at the second functional section 51.2 obliquely to its insertion direction to secure the locking position. This locking pin 511 is inserted via a first passage opening 512a from one side of the functional section 51.2 until the locking pin 511 bridges an interior space that is enclosed by the second functional section 51.2 and protrudes from a second securing opening 51.1b of the second functional section 51.2 that is located opposite. The position of the locking pine 511 is axially secured at this projecting end of the locking pine 511 through a securing element in the form of a retaining ring 513. The locking pin 511 thus attached at the second functional section 51.2 extends between two facing [walls] that respectively comprise one of the passage openings 51.1a, 51.1b, inside the second functional section 51.2 and past the other axial end of the arresting pin 500 which is in the locking position. In this way, the locking pin 511 that is inserted obliquely with respect to the extension of the arresting pin 500 blocks any displacement of the arresting pin 500 counter to the original insertion direction in the manner of a latch. The arresting pin 500 is thus secured against any displacement from its locking position by means of the locking pin 511. At that, for the axial securing of the arresting pin 500, the locking pin 511 can for example be made of metal.

Further, the arresting pin 500 is dimensioned in such a manner and preferably made of a brittle and, where required, ceramic material that it is provided that the arresting pin 500 fails in the event of a pressure inside the hollow space 100 of the splitter fairing 1 exceeding a threshold value, and thus the fixation of the overpressure flap 3 at the arresting plate 50 and consequently also the fixation of the overpressure flap in the closed position is released. Through the axially spaced apart mounting of the arresting pin 500 at two mounting or securing openings in the arresting plate 51 one the one hand and the locking unit 50 on the one hand, it can be achieved that, in the event of an overpressure occurring, the arresting pin 500 usually shears off in the intermediate area between the two parts 50 and 51 of the arresting appliance 5, and thus releases the overpressure flap 3.

### PARTS LIST

1 splitter fairing
10 rear shell surface
100 hollow space
11 lateral shell surface
2 trailing edge element
20 predetermined breaking point (weakening area)
21a, 21b flap section
22a, 22b hinge element
3 overpressure flap
30, 30.1, 30.2 hinge element
300 passage
31, 31.1-31.4 retaining tap
310 retaining pin (attachment element)
3100 predetermined breaking point (weakening area)
310a, 310b pin half
32 gap
33 predetermined breaking point (weakening area)
34a, 34b recess
3a, 3b flap section
4a-4e stiffening element
5 arresting appliance
50 locking unit with arresting piece
500 arresting pin (arresting piece)
51 arresting plate with securing opening
51.1, 51.2 functional section
51.1a, 51.1b securing opening
510 mounting opening
511 locking pin (locking element)
512a, 512b passage opening
513 retaining ring (securing element)
A outlet
AL outlet conduit
B combustion chamber section
BD bypass channel
F fan
K core engine
L1, L2 conduit
M central axis/rotational axis
S (bypass) flow
T turbofan engine
TT turbine
V compressor
VK splitter fairing

1. A turbofan engine, comprising
a core engine and at least one fan by means of which fluid is guided to a primary flow channel for the core engine as well as to a secondary flow channel of the turbofan engine, wherein the secondary flow channel is provided for an outer fluid flow that is guided past the core engine, and
at least one conduit that is guided inside a hollow space of a splitter fairing that is arranged in the secondary flow channel, wherein
the splitter fairing has at least one overpressure flap with at least one deformable hinge element, with the overpressure flap being flappable if a pressure inside the hollow space exceeds a threshold value, with the deformable hinge element being deformed in the process, and
at least one opening mechanism is provided by means of which, in the event that the pressure inside the hollow space exceeds a threshold value, a fixation of the overpressure flap is released to allow for a flapping out of the overpressure flap.

2. The turbofan engine according to claim 1, wherein the opening mechanism comprises at least one arresting appliance that arrests the overpressure flap in a closed position in which it is not flapped open at the splitter fairing and releases the overpressure flap in the event that the pressure inside the hollow space exceeds a threshold value, so that the overpressure flap protrudes at least partially into the secondary flow channel.

3. The turbofan engine according to claim 2, wherein, if the overpressure flap is released by means of the arresting appliance, the hinge element
a) at first allows for the overpressure flap to be flapped into an intermediate position, in which a part of the overpressure flap protrudes into the secondary flow channel, and
b) subsequently allows for the overpressure flap to be flapped open further under the influence of the fluid flowing inside the secondary flow channel that impinges on that part of the overpressure flap that protrudes into the secondary flow channel.

4. The turbofan engine according to claim 3, wherein the hinge element and the arresting appliance are arranged in such a manner at the splitter fairing that, in the event that the pressure inside the hollow space exceeds a threshold value, the overpressure flap that is released by means of the arresting appliance flaps into an intermediate position, in which that part of the overpressure flap that protrudes into the secondary flow channel is located upstream of the hinge element with respect to the flow direction of the fluid inside the secondary flow channel.

5. The turbofan engine according to claim 1, wherein the opening mechanism comprises at least one predefined weakening area at which a material failure occurs in the event that the pressure inside the hollow space exceeds a threshold value so as to allow for the overpressure flap to flap out.

6. The turbofan engine according to claim 5, wherein the at least one weakening area is formed at an element and/or a section by means of which the overpressure flap is held in a closed position in which it is not flapped out.

7. The turbofan engine according to claim 6, wherein the at least one weakening area is formed at an element that is connected to the overpressure flap.

8. The turbofan engine according to claim 7, wherein the at least one weakening area is formed at an attachment element by means of which the overpressure flap is fixated in the closed position with respect to a shell surface of the splitter fairing, and which fails in a defined manner at the at least one weakening area in the event that a pressure inside the hollow space exceeds the threshold value.

9. The turbofan engine according to claim 8, wherein the overpressure flap is fixated in the closed position by means of multiple retaining elements that are provided at the shell surface of the splitter fairing, wherein the overpressure flap is connected to each retaining element by means of at least one attachment element.

10. The turbofan engine according to claim 6, wherein the at least one weakening area is formed between two sections of the overpressure flap that can be flapped open separately.

11. The turbofan engine according to claim 1, wherein the overpressure flap can be flapped into the secondary flow channel in the event that the pressure inside the hollow space exceeds the threshold value, with the at least one hinge element being deformed in the process.

12. The turbofan engine according to claim 1, wherein the at least one hinge element is formed by an area at a shell surface of the splitter fairing that has a reduced wall thickness and/or by at least one recess in the shell surface.

13. The turbofan engine according to claim 1, wherein the splitter fairing is connected to a separate trailing edge element which defines a trailing edge that lies in the flow direction of the fluid inside the secondary flow channel.

14. The turbofan engine according to claim 13, wherein the overpressure flap can be flapped into an intermediate space that is delimited by the trailing edge element in the event that a pressure inside the hollow space exceeds a threshold value, with the at least one hinge element being deformed in the process.

15. The turbofan engine according to claim 14, wherein the trailing edge element has a passage opening that connects the intermediate space to the secondary flow channel, and/or that the trailing edge element has at least one additional overpressure flap that can be flapped into the secondary flow channel as it fails at least at one further weakening area, and with at least one further hinge element being deformed if the pressure inside the intermediate space exceeds a threshold value.
